(19) United States
(12) Patent Application Publication
(10) Pub. No.: US 2013/0077837 A1
(43) Pub. Date: Mar. 28, 2013

(54) FUZZY CLUSTERING ALGORITHM AND ITS APPLICATION ON CARCINOMA TISSUE

(71) Applicants: Cyril Gobinet, Athies sous Laon (FR); Pierre Jeannesson, Reims (FR); Michel Manfait, Verzy (FR); Olivier Piot, Cormontreuil (FR); David Sebiskveradze, Reims (FR); Valeriu Vrabie, Reims (FR)

(72) Inventors: Cyril Gobinet, Athies sous Laon (FR); Pierre Jeannesson, Reims (FR); Michel Manfait, Verzy (FR); Olivier Piot, Cormontreuil (FR); David Sebiskveradze, Reims (FR); Valeriu Vrabie, Reims (FR)

(73) Assignee: GALDERMA RESEARCH & DEVELOPMENT SNC, Biot (FR)

(21) Appl. No.: 13/637,092

(22) PCT Filed: Mar. 25, 2011
(86) PCT No.: PCT/EP11/54595

§ 371 Date: Dec. 6, 2012

Related U.S. Application Data
(60) Provisional application No. 61/282,767, filed on Mar. 29, 2010.

(51) Int. Cl. G06K 9/62

(52) U.S. Cl. CPC G06K 9/6218
USPC 382/128

(57) ABSTRACT

This invention relates to a method for identifying and classifying carcinomas on the skin of a subject by a FTIR or Raman spectrometer coupled with a micro-imaging system.

### CROSS-REFERENCE TO RELATED APPLICATION

This application is entitled to priority U.S. Provisional Patent Application No. 61/282767, filed Mar. 26, 2010. The content the application is hereby incorporated by reference in its entirety.

### BACKGROUND OF THE INVENTION

The biochemical changes related to carcinogenesis between cancerous and surrounding tissue areas are subtle. As a consequence, spectral images, such as IR and Raman spectra, need to be processed by powerful digital signal processing and pattern recognition methods in order to highlight these changes. To date, unsupervised “hard” clustering techniques including K-means (KM) or agglomerative hierarchical (AH) clustering have been usually applied to create color-coded images allowing to localize tumoral tissue surrounded by other tissue structures (normal, inflammatory, fibrotic . . . ).

The particularity of “hard” clustering methods is that each pixel (spectrum) is assigned to only one cluster. Consequently, they neither allow to consider the progressive transition between noncancerous tissues and cancer lesions, nor to reveal every nuance of intratumoral heterogeneity. See Wolthuis, R.; Travo, A.; Nicolet, C.; Neuville, A.; Gaub, M. P.; Guennot, D.; Ly, E.; Manfait, M.; Jeannesson, P.; Piot, O. Analytical Chemistry 2008, 80, 8461-8469.

To overcome this drawback, fuzzy clustering methods such as fuzzy C-means (FCM) can be used instead of “hard” clustering algorithms. See Bezdek, J. C. Pattern recognition with fuzzy objective function algorithms; Plenum: New York, USA, 1981. Indeed, FCM allows each pixel to be assigned to every cluster with an associated membership value varying between 0 (no class membership) and 1 (highest degree of cluster membership). In IR spectroscopy, FCM has been used for data analyzing.

However, such as for “hard” KM clustering, the number of clusters K must be defined a priori by the user. The FCM results are thus dependent from the operator-experience. In addition, FCM outcomes are dependent on another important parameter, called the fuzziness index m in the fuzzy logic literature. When m=1, FCM becomes identical to KM and when m increases, the clustering becomes fuzzier. At very high values of m, data will have an equal membership for all the clusters. In IR or Raman data processing, this can lead to create redundant cluster images, in which only some pixels differ from one cluster to another. However, the fuzziness index is classically fixed to 2 in the literature. The choice of an efficient trade-off between K and m, necessary to fully exploit the information content of hyperspectral images, is still an open problem. See Mansfield, J. R.; Sowa, M. G.; Scarth, G. B.; Somorjai, R. L.; Mantsch, H. H., Analytical Chemistry 1997, 69, 3370-3374; and Richter, T.; Steiner, G.; Abu-Id, M. H.; Salzer, R.; Bergmann, R.; Rodig, H.; Johannsen, B., Vibrational Spectroscopy 2002, 28, 103-110. Indeed, as recently shown for colorectal adenocarcinoma, when the (K, m) couple is not optimized, FCM clustering proved to be less efficient than AH clustering in terms of tissue histopathological recognition. See Lasch, P.; Haensch, W.; Naumann, D.; Diem, M., Biochimica et Biophysica Acta 2004, 1688, 176-186.

The present invention offers a novel algorithm dedicated to spectral images of tumoral tissue, which can automatically estimate the optimal values of K, number of non-redundant FCM clusters, and m, fuzziness index, without any a priori knowledge of the dataset. This innovative algorithm is based on the redundancy between FCM clusters. This algorithm is particularly well adapted to localize tumoral areas and to highlight transition areas between tumor and surrounding tissue structures. For the infiltrative tumors, a progressive gradient in the membership values of the pixels of the peritumoral tissue is also revealed.

### SUMMARY OF THE INVENTION

The present invention provides a fuzzy C-means (FCM) clustering algorithm for processing spectral images of a tissue sample. The algorithm automatically and simultaneously estimates the optimal values of K (number of non-redundant FCM clusters), and m (fuzziness index), based on the redundancy between FCM clusters.

The present invention also provides a method for characterizing the tumor heterogeneity of a lesion. According to the present invention, the characterization was conducted by the following steps: a) scanning a lesion on a tissue sample by a FTIR or Raman spectrometer coupled with a micro-imaging system; b) acquiring and storing spectra of a series of digital images of the lesion; c) clustering the spectra by fuzzy C-means (FCM) clustering algorithm. Further, the algorithm automatically and simultaneously estimates the optimal values of K (number of non-redundant FCM clusters), and m, (fuzziness index) based on the redundancy between FCM clusters.

### DESCRIPTION OF FIGURES

FIG. 1: Two representative IR spectra before and after EMSC-based preprocessing. After the application of this method, the contribution of paraffin is fixed to the same amplitude on all recorded spectra and is thus considered as being neutralized. In the FIG. 1(b), the paraffin bands are localized in the spectral range 1340-1480 cm⁻¹ and the tissue bands, in the spectral range 1030-1340 and 1500-1720 cm¹.

FIG. 2: General scheme of the redundancy based algorithm (RBA) that permits to construct the curves of the number of non-redundant clusters Kₙᵣ^{s}(m) as a function of m.

FIG. 3: “Hard” clustering color-coded images on FT-IR dataset of a superficial human skin BCC sample. Panel (a): H&E-stained section (* epidermis, + dermis, BCC is outlined). Panel (b): KM color-coded image. Panels (c and d): HHAC color-coded image and corresponding dendrogram. Each color corresponds to one cluster.

FIG. 4: FCM images with unoptimized parameters (K=11 and m=2) on FT-IR dataset of the human skin BCC sample. Clusters 1, 2, 3 and 4 are redundant clusters associating epidermis and tumor, while 5, 6, 7, 8 and 9 are redundant clusters of the dermis. Clusters 10 and 11 are non-redundant clusters describing the dermis. The color bar represents the scale of membership value for each pixel. In the corresponding H&E-stained section, BCC is outlined, epidermis (*) and dermis (+) are indicated.

FIG. 5: “Hard” clustering color-coded images on FT-IR dataset of a human skin Bowen's disease sample. Panel (a): H&E-stained section (* epidermis, + dermis, Bowen's disease is outlined). Panel (b): KM color-coded image. Panels (c and d): HHAC color-coded image and corresponding dendrogram. Each color corresponds to one cluster.

FIG. 6: FCM images with unoptimized parameters (K=11 and m=2) on FT-IR dataset of the human skin Bowen's disease sample. Clusters 1 and 4 are redundant clusters of the dermis, as well as clusters 2 and 9, and clusters 6 and 7. Clusters 5, 8, and 10 are redundant for the epidermis. Clusters 3 and 11 describe the Bowen's disease. The color bar represents the scale of membership value for each pixel. In the corresponding H&E-stained section, Bowen's disease is outlined, epidermis (*) and dermis (+) are indicated.

FIG. 7: “Hard” clustering color-coded images on FT-IR dataset of an infiltrative human skin SCC sample. Panel (a): H&E-stained section, the tumor is outlined. Panel (b): KM color-coded image. Panels (c and d): HHAC color-coded image and corresponding dendrogram. Each color corresponds to one cluster.

FIG. 8: FCM images with unoptimized parameters (K=11 and m=2) on FT-IR dataset of the human skin SCC sample. Clusters 1 and 4 are redundant clusters of the epidermis, while 3 is a non-redundant cluster. For the dermis, clusters 2, 5, and 11 are redundant, as for clusters 7 and 9. Clusters 6, 8, and 10 are dissociated clusters describing the tumor. The color bar represents the scale of membership value for each pixel. In the corresponding H&E-stained section, the tumor is outlined.

FIG. 9: Number of non-redundant clusters Kₙᵣ^{s}^{ₗ}(m) as a function of the fuzziness index m estimated by the RBA for the SCC sample. Each curve corresponds to a given value of the threshold sₗ.

FIG. 10: FCM images on FT-IR dataset of the human skin SCC sample constructed with RBA optimized parameters \hat{K}ₒₚₜ=6 (number of clusters) and \hat{m}ₒₚₜ=2.06 (fuzziness index). Assignment of the clusters: cluster 1 (tumor); 2 (peritumoral area); 3, 4 and 5 (dermis); 6 (epidermis). The color bar represents the scale of membership value for each pixel. In the corresponding H&E stained section, SCC is outlined.

FIG. 11: Analysis of the tumor/surrounding dermis interface by zooming the FCM images depicted in FIG. 10. Cluster 2, characterizing the invasive front of the tumor is also shown in a 3D representation. The color bar represents the scale of membership value for each pixel.

FIG. 12: FCM images on FT-IR dataset of the human skin superficial BCC sample after RBA clustering. FCM images (panel a) were constructed with optimized parameters \hat{K}ₒₚₜ=5 and \hat{m}ₒₚₜ=1.6. These parameters were defined using the RBA-resulting curves (panel b) and Table 2. Assignment of the clusters: cluster 1 (epidermis); 2, 3 and 4 (dermis); 5 (tumoral areas). The color bar represents the scale of membership value for each pixel. In the corresponding H&E-stained section, BCC is outlined, epidermis (*) and dermis (+) are indicated.

FIG. 13: FCM images on FT-IR dataset of the Bowen's disease sample after RBA clustering. FCM images (panel a) were constructed with optimized parameters \hat{K}ₒₚₜ=5 and \hat{m}ₒₚₜ=1.77. These parameters were defined using the RBA-resulting curves (panel b) and Table 3. Assignment of the clusters: cluster 1 (epidermis); 2, 3 and 4 (dermis); 5 (Bowen's disease). The color bar represents the scale of membership value for each pixel. In the corresponding H&E-stained section, Bowen's disease is outlined, epidermis (*) and dermis (+) are indicated.

### DETAILED DESCRIPTION OF THE INVENTION

### EXAMPLES

### Example 1

### Materials and Methods

### Sample Preparation

The developed algorithm was applied on the IR datasets acquired on 13 biopsies of formalin fixed paraffin-embedded human skin carcinomas: squamous cell carcinomas (SCC, n=3), basal cell carcinomas (BCC, n=4) and Bowen's diseases (n=6). The samples were obtained from the tumor bank of the Pathology Department of the University Hospital of Reims (France). Ten micron-thick slices were cut from samples and mounted, without any particular preparation, on a calcium fluoride (CaF2) (Crystran Ltd., Dorset, UK) window for FT-IR imaging. Adjacent slices were cut and stained with hematoxylin and eosin (H&E) for conventional histology.

### FTIR Data Collection

FT-IR hyperspectral images were recorded with a Spectrum Spotlight 300 FT-IR imaging system coupled to a Spectrum one FT-IR spectrometer (Perkin Elmer Life Sciences, France) with a spatial resolution of 6.25 μtm and a spectral resolution of 4 cm⁻¹. The device was equipped with a nitrogen-cooled mercury cadmium telluride 16-pixel-line detector for imaging. Spectral images, also called datasets, were collected using 16 accumulations. Prior to each acquisition, a reference spectrum of the atmospheric environment and the CaF2 window was recorded with 240 accumulations. This reference spectrum was subsequently subtracted from each dataset automatically by a built-in function from the Perkin Elmer Spotlight software. Each image pixel represented an IR spectrum, which was the absorbance of one measurement point (6.25×6.25 μm²) over 451 wavenumbers uniformly distributed between 900 and 1800 cm⁻¹. This spectral range, characterized as the fingerprint region, actually corresponded to the most informative region for the biological samples.

### Data Processing

The samples were analyzed without previous chemical dewaxing, the recorded FT-IR hyperspectral image must be digitally corrected for paraffin spectral contribution. To this end, an automated processing method based on extended multiplicative signal correction (EMSC) was applied on each recorded dataset. The details of the corresponding analytical method was fully described by Ly, E.; Piot, O.; Wolthuis, R.; Durlach, A.; Bernard, P.; and Manfait, M., (Analyst 2008, 133, 197-205), which is herein adopted in its entirety. Briefly, a mean spectrum I was computed by averaging all Q recorded spectra I_{q} of each dataset. Light scattering effects were modeled with a fourth-order polynomial function P. The interference matrix M was composed of the average spectrum of paraffin and the first 9 principal components extracted from a FT-IR spectral image recorded on a pure paraffin block, in order to take into account the spectral variability of the paraffin. Each recorded spectrum I_{q} is fitted with I, P, and M by using a least square approach:

I_{q}=α_{q}I+β_{q}P+γ_{q}M+e_{q}, q=1, . . . , Q.

The residue e_{q}, giving an estimation of the accuracy of the fitting model, is used to obtain the EMSC-corrected spectra:

I_{q}^{corr}=I+e_{q}/α_{q}.

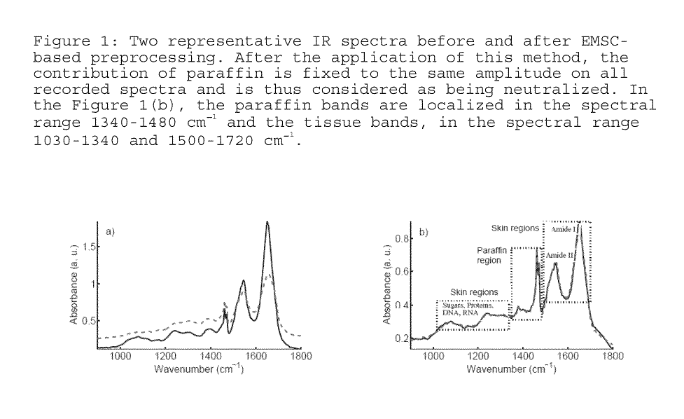

After the application of EMSC-based preprocessing, paraffin contribution was neutralized and permitted to retain in the datasets only the spectral variability of the tissue and to normalize the corrected spectra around the mean spectrum. Two IR spectra before and after EMSC-based preprocessing are shown in FIG. 1.

In addition, this pre-processing made it possible to discard from the analysis outliers spectra with poor signal-to-noise ratio. The corresponding pixels were white-colored at the clustering color-coded images for better visualization.

### Example 2

### Experiments with Existing Clustering Methods

The main objective of clustering is to find similarities between spectral datasets and then group similar spectra together in order to reveal areas of interest within tissue sections. In cancer research, clustering methods allow creating highly contrasted color-coded images permitting to localize tumoral areas within a complex tissue. Details of the clustering method is described by Ly, E.; Piot, O.; Wolthuis, R.; Durlach, A.; Bernard, P.; and Manfait, M., (Analyst 2008, 133, 197-205) and by Lasch, P.; Haensch, W.; Naumann, D.; and Diem, M. (Biochimica et Biophysica Acta 2004, 1688, 176-186), which are adopted herein in their entirety.

### “Hard” Clustering

KM clustering is a non-hierarchical partition clustering method. The aim of KM was to minimize an objective function based on a distance measure between each spectrum and the centroid of the cluster to which the spectrum was affected. This algorithm iteratively partitioned the data into K distinct clusters. Here, KM clustering was performed several times (n>10) to make sure a stable solution was reached, and to overcome the random initialization dependence. In this study, KM was applied using the Matlab Statistics Toolbox with the classical Euclidean distance. The process was continued until no spectrum was reassigned from one iteration to the following, otherwise it was stopped after 10⁴ iterations.

AH clustering is a hierarchical partition clustering, in which each object (spectrum in our case) is one cluster at the beginning of the algorithm. At each iteration step, AH regroups the two clusters that are the most similar into a new cluster. The algorithm is stopped when the all spectra are combined into one single cluster. For Q spectra, the number of iterations equals to Q−1. AH clustering process is independent of initialization. However, like for KM, in AH clustering, the number of clusters K is empirically chosen. Compared to KM, AH clustering is significantly more time- and resource-consuming.

In order to reduce the computational time of AH clustering on our large dataset, we used here an efficient hybrid hierarchical agglomerative clustering (HHAC) technique that combined KM and AH clusterings using Euclidean distance and Ward's algorithm, which was described by Vijaya, P. A.; Murty, M. N.; Subramanian, D. K. in Lecture Notes in Computer Science 2005, 3776/2005, 583-588 and adopted herein in its entirety. KM was first applied to reduce the datasets to 1000 cluster centers. AH was then carried out on these 1000 KM centroids.

### FCM Clustering

The FCM clustering is based on the minimization of the objective function Jₘ:

Iₘ=Σ_{q-1}^{Q}Σₖ₌₁^{K}u_{qk}^{m}∥I_{q}^{corr}−vₖ∥²

defined as the sum of the within cluster errors (computed as the Euclidian distance, i.e. L2 norm, ∥.∥, between the Q available corrected spectra I_{q}^{corr} and the K cluster centroids vₖ), weighted by the membership values u_{qk}. The cluster centroids and the membership values that minimize this objective function are obtained by using an iterative optimization procedure (see Bezdek, J. C. Pattern recognition with fuzzy objective function algorithms; Plenum: New York, USA, 1981). The weight is controlled by the fuzziness index m. Therefore, contrary to “hard” clustering, FCM permits to affect each spectrum I_{q}^{corr} to every cluster k (k=1, . . . , K) with the associated membership value u_{qk} varying between 0 and 1; the sum of the K cluster membership values for each spectrum being equal to 1, i.e. Σₖ₌₁^{K}u_{qk}=1.

Here we applied the FCM function from the Matlab Statistics Toolbox. A maximum number of 500 iterations and a setting of 10⁻⁵ for the minimal amount of improvements (at the level of the sum of each spectrum/centroid distance) were used as the stopping criteria. However, FCM required to fix the number of clusters K and the fuzziness index m. An inappropriate choice of these parameters could lead to an uninterpretable clustering of the data. The development of an automatic method to optimally estimate these parameters was thus essential.

### Example 3

### Development of the Redundancy Based Algorithm for the Optimal Estimation of FCM Parameters

This innovative algorithm (RBA), based on the FCM clusters redundancy, aimed at determining an optimal couple (Kₒₚₜ, mₒₚₜ) without any a priori knowledge of the dataset. We had chosen here the intercorrelation coefficient Rᵢⱼ(K,m) between two clusters i and j as the measure of redundancy:

$${R}_{ij} ( K , m ) = \frac{C ( i , j )}{\sqrt{C ( i , i ) C ( j , j )}}$$

where c(i,j)=Σ_{q=1}^{Q}(u_{qi}−ūᵢ)(u_{qj}−ūⱼ) is the covariance between the membership values of clusters i and j given by FCM for a couple (K,m), c(i,i)=Σ_{q-1}^{Q}(u_{qi}−ūᵢ)² and c(j,j)=Σ_{q=1}^{Q}(u_{qj}−−ūⱼ)² are the variances of the membership values of cluster i and j, with the means

$${\overline{u}}_{i} = \frac{1}{Q} {\sum }_{q = 1}^{Q} {u}_{qi} and {\overline{u}}_{j} = \frac{1}{Q} {\sum }_{q = 1}^{Q} {u}_{qj} .$$

The RBA is composed of three steps. Firstly, the iterative process for the reduction of the number of clusters was performed. For this step, N different values of the fuzziness index belonging to the set m={m₁, . . . , mₙ, . . . , m_{N}} and L different values of the threshold belonging to the set s={s₁, . . . , sₗ, . . . , s_{L}} were considered. m is composed of N different values of the fuzziness index m, uniformly distributed around the classical value m=2, while s is composed of L different values of threshold uniformly distributed into the high correlation coefficient range 50% to 95%. FCM clustering started with m₁, s_{L} and a large value of the number of clusters K, i.e. K=Kₘₐₓ. In a general manner, for a triplet of the values (mₙ, s₁, K), the intercorrelation coefficients Rᵢⱼ(K,mₙ), with 1≦i,j≦K, were computed. If one of the Rᵢⱼ(K,mₙ) values was superior to s₁, a new FCM was run with K=K−1. Otherwise, if all the values of Rᵢⱼ(K,mₙ) were less than the threshold value s₁, the number of non-redundant clusters Kₙᵣ^{s}^{ₗ}(mₙ) (corresponding to the last value of K) was obtained. The subscript “nr” is used in the following to denote the non-redundancy of clusters.

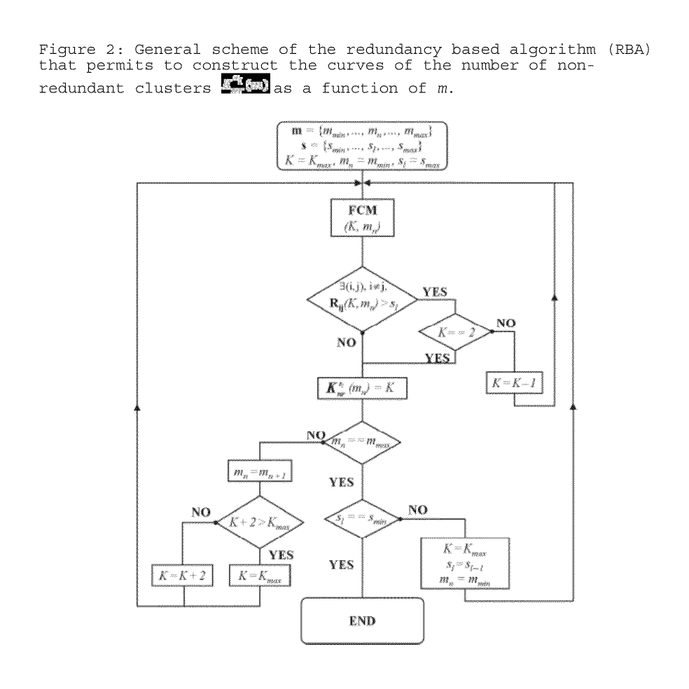

By performing this procedure for the different values of m and a fixed threshold sₗ, a curve of the number of non-redundant clusters Kₙᵣ^{s}^{ₗ}(m) was obtained as a function of m. The iterative process of the reduction of the number of clusters for the next m (i.e. mₙ₊₁ which belongs to the set m) should restart with an initial value of K equals to the number of non-redundant clusters estimated for the previous m, i.e. K=Kₙᵣ^{s}^{ₗ}(mₙ). However, the FCM algorithm being randomly initialized, the estimated number of non-redundant clusters could vary from one clustering to another. In order to take this possible variation into account, the initial value of K for the next m was set to the number of non-redundant clusters for the previous m plus two, i.e. K=Kₙᵣ^{s}^{ₗ}(mₙ)+2, however without exceeding Kₘₐₓ. By executing this procedure for the all values of the set s, the resulting Kₙᵣ^{s}^{ₗ}(m) curves were obtained for each threshold value sᵢ. The global procedure is depicted in FIG. 2.

Secondly, the RBA consists in the optimal estimation of the number of clusters from the obtained curves. As presented in the Results and discussion section, these curves decreased rapidly and become stable at the \hat{K}ₒₚₜ^{s}^{ₗ} value, where “̂”denotes (here and hereafter) an estimator. Whatever the threshold sₗ was, we usually observed that the breakings in these curves appeared for close values \hat{K}ₒₚₜ^{s}^{ₗ} and often for the same value. A majority voting algorithm is used to identify the final optimal value \hat{K}ₒₚₜ of the number of clusters.

Finally, the optimal value \hat{m}ₒₚₜ of the fuzziness index is computed by averaging the smallest values \hat{m}ₒₚₜ^{s}^{ₗ} for which the curves Kₙᵣ^{s}^{ₗ}(m) presented a break at \hat{k}ₒₚₜ:

\hat{m}ₒₚₜ=meanₛ_{ₗ}_{EB}(\hat{m}ₒₚₜ^{s}^{ₗ}), with \hat{m}ₒₚₜ^{s}^{ₗ}=min(arg(Kₙᵣ^{s}^{ₗ}(m)=\hat{K}ₒₚₜ^{s}^{ₗ})).

Hereafter, FCM clustering performed with these RBA-optimized parameters will be defined as FCM-RBA.

### Results and Discussions:

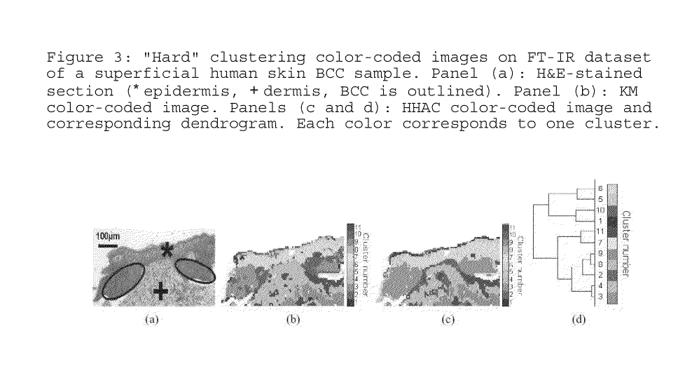

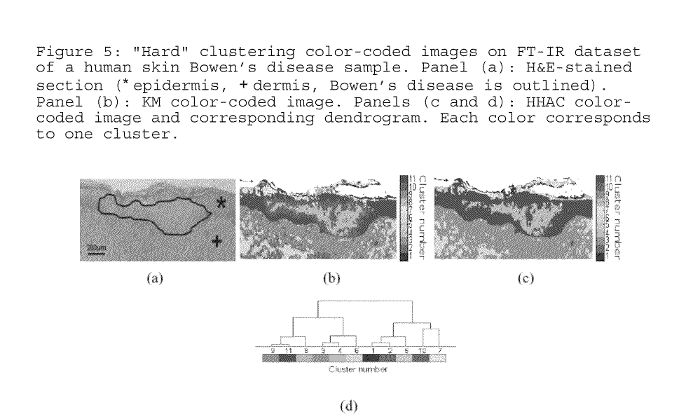

The FCM-RBA clustering was assessed on EMSC-preprocessed FT-IR hyperspectral images acquired on thin tissue sections of 13 human skin carcinomas. The results were compared with KM, HHAC and classical FCM outcomes. To improve the reading of this section, we presented these comparative results for an infiltrative SCC. In addition, FCM-RBA clustering data were given for non-infiltrative states of a superficial BCC and a Bowen's disease, whereas corresponding KM, HHAC and FCM outcomes were presented in FIG. 3-FIG. 6.

### “Hard” Clustering Results

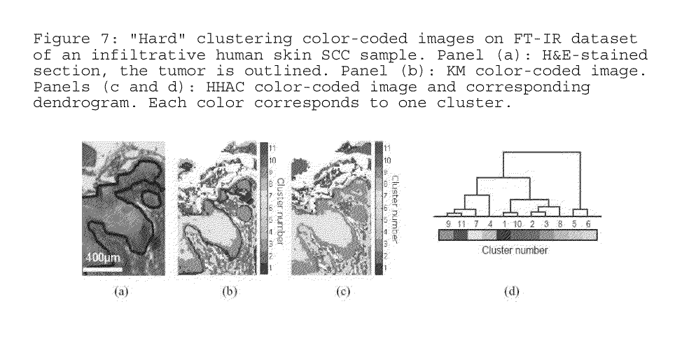

The H&E-stained histological image of the studied SCC sample, on which the tumor is outlined, is provided in FIG. 7(a).

To highlight the distinctive histological regions of this paraffin-embedded tissue section, KM clustering was applied with an empirical choice of 11 clusters. The resulting color-coded image is shown in FIG. 7(b), in which each color was associated to one cluster.

Comparison of KM and HHAC images with the corresponding H&E-stained section permitted an assignment of the clusters. As shown here for KM clustering (FIG. 7(b)), the pixels belonging to the tumor were grouped into clusters 1, 7 and 9, revealing an intra-tumor heterogeneity. The dermis was represented by clusters 2, 3, and 6, and the ulcerated epidermis by clusters 4, 5, 8, 10, and 11. As depicted in FIG. 7(c), HHAC clustering results were quite similar to those of KM; the corresponding dendrogram used to construct the HHAC color-coded image is presented in FIG. 7(d).

These results indicate that “hard” clustering algorithms were able to retrieve the histological structures and especially to localize tumoral areas within the tissue section. However, the choice of the number of clusters was a difficult problem that is usually empirically resolved. When less than 11 clusters were chosen, the histological regions identified by clustering algorithms were mixed and the intra-tumor heterogeneity was no more revealed. With more than 11 clusters, no further interpretable information was obtained. Furthermore, the principal drawback of these “hard” clustering methods was that the cluster membership grade of each individual spectrum equaled to 0 or 1, which did not permit to differentiate the nuances of pixel membership. Consequently, these techniques did not allow to consider progressive transitions likely to exist at he invasion front of a tumor or between heterogeneous intratumoral areas.

Classical FCM clustering

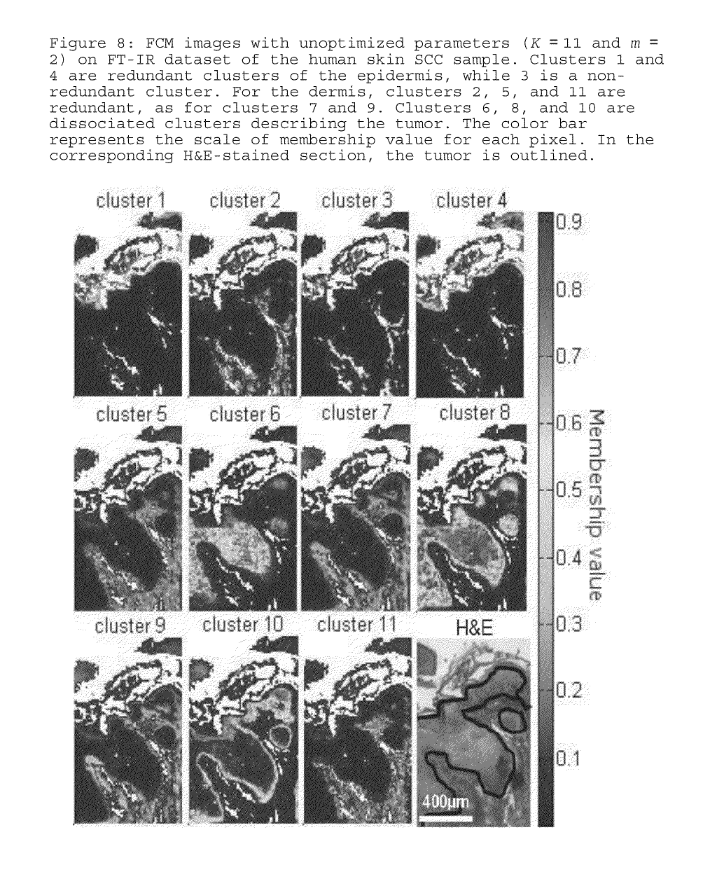

The results obtained by using the FCM algorithm without optimized parameters on the same dataset are shown in FIG. 8. The fuzziness index m was fixed to the commonly used default value of 2, according to investigations of other groups. Eleven clusters were chosen as they allow an unequivocal reproduction of the H&E-based histology as previously described with “hard” clusterings (FIG. 7). Each cluster was presented into a separate image instead of superimposing them into only one color-coded image. Indeed, the superimposing presentation made the highlighting of transitional structures difficult.

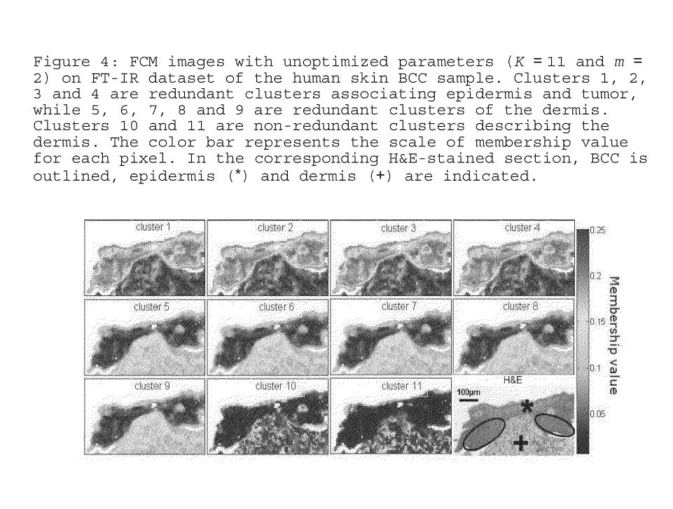

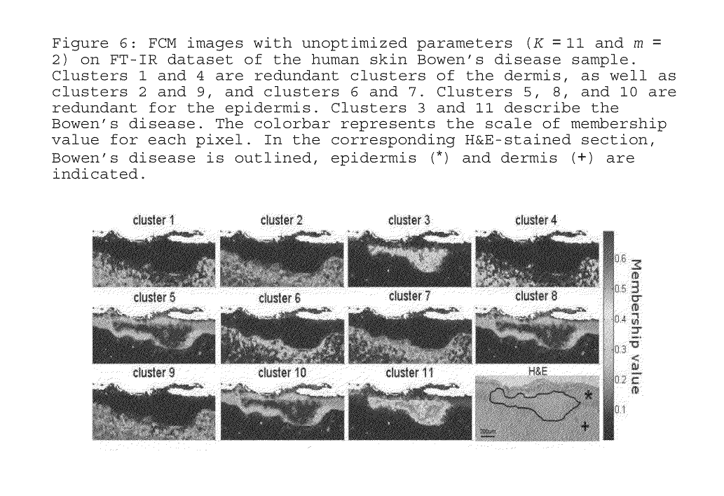

A visual comparison of the clusters presented in FIG. 8 revealed important redundancies. This was confirmed by the inter-correlation coefficients Rᵢⱼ between the computed images. Indeed, clusters 7 and 9 were correlated with a Rᵢⱼ coefficient equal to 98.3%, 5 and 7 with 82.6%, 5 and 11 with 78.6%, and finally 1 and 4 with 76.7%. Similar redundancies were observed on all IR hyperspectral images collected on the set of studied skin cancers; two of them are shown in FIG. 4 and FIG. 6.

These results demonstrated that classical FCM created non-informative redundant images in which only few pixels differed from one cluster to another. Therefore, it was essential to choose the optimal couple of K and m parameters to obtain a biologically-relevant clustering.

### Optimization of FCM Parameters Using RBA

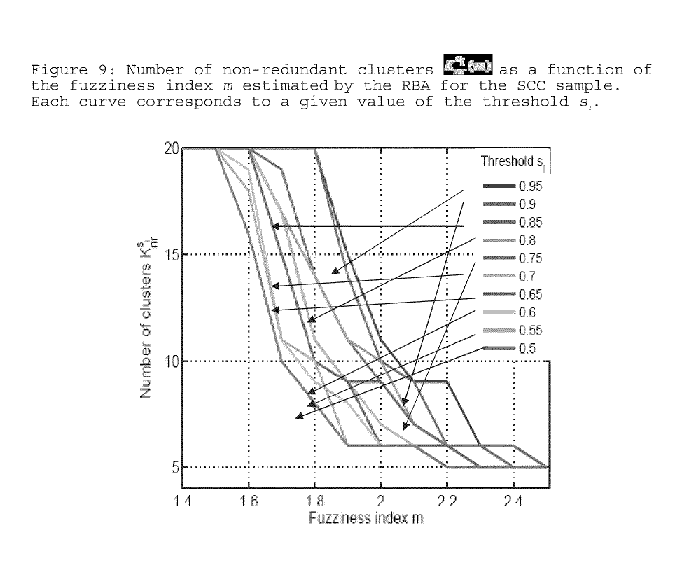

Simultaneous determination of optimal K and m parameters was performed using an innovative algorithm (RBA). In our investigation, a value of Kₘₐₓ=20, a set of fuzziness indices m={1.4, 1.5, . . . , 2.5}, and a set of thresholds s={0.5, 0.55, . . . , 0.95} were tested. The curves Kₙᵣ^{s}^{ₗ}(m), representing the number of non-redundant clusters as a function of m obtained by this method for the different values of the threshold sₗ are shown in FIG. 9 for the SCC sample. Each curve tended to quickly decrease towards a Kₒₚₜ^{s}^{ₗ} value, from which the curves become quite stable. The \hat{K}ₒₚₜ^{s}^{ₗ} values and the corresponding \hat{m}ₒₚₜ^{s}^{ₗ} values for these thresholds are indicated in Table 1. The optimal number of clusters \hat{K}ₒₚₜ^{s}^{ₗ} has thus been estimated by using a majority voting algorithm as equal to 6. The resulting optimal value \hat{m}ₒₚₜ was determined as the average of the values of \hat{m}ₒₚₜ^{s}^{ₗ} obtained for Kₒₚₜ^{s}^{ₗ}=6, and was equal to 2.06. The developed RBA was successfully applied on all IR hyperspectral datasets collected on the set of studied skin cancers.

TABLE 1
Optimal number of clusters \hat{K}ₒₚₜ^{s}^{ₗ} and the corresponding optimal values
of the fuzziness index \hat{m}ₒₚₜ^{s}^{ₗ}. These data have been determined for 10
different values of the threshold sₗ from the curves presented in FIG. 9.

| | sₗ | | | | | | | | | |
|---|---|---|---|---|---|---|---|---|---|---|
| | 0.95 | 0.9 | 0.85 | 0.8 | 0.75 | 0.7 | 0.65 | 0.6 | 0.55 | 0.5 |
| \hat{K}ₒₚₜ^{s}^{ₗ} | 9 | 6 | 6 | 6 | 9 | 6 | 6 | 6 | 6 | 6 |
| \hat{m}ₒₚₜ^{s}^{ₗ} | 2.1 | 2.2 | 2.2 | 2.2 | 1.9 | 2.1 | 2 | 2 | 1.9 | 1.9 |

It has to be mentioned, that in our case, classical validity indices used to determine the optimal number of FCM clusters K failed to correlate with standard histopathology. Indeed, the partition coefficient and classification entropy (see Bezdek, J. C. Pattern recognition with fuzzy objective function algorithms; Plenum: New York, USA, 1981) applied with m=2 give an aberrant value of K=2 that did not permit to reveal the different tissue structures. These data reinforced the relevancy of our developed RBA in terms of tissue structure differentiation.

### Histopathological Recognition of Skin Carcinomas Using FCM-RBA

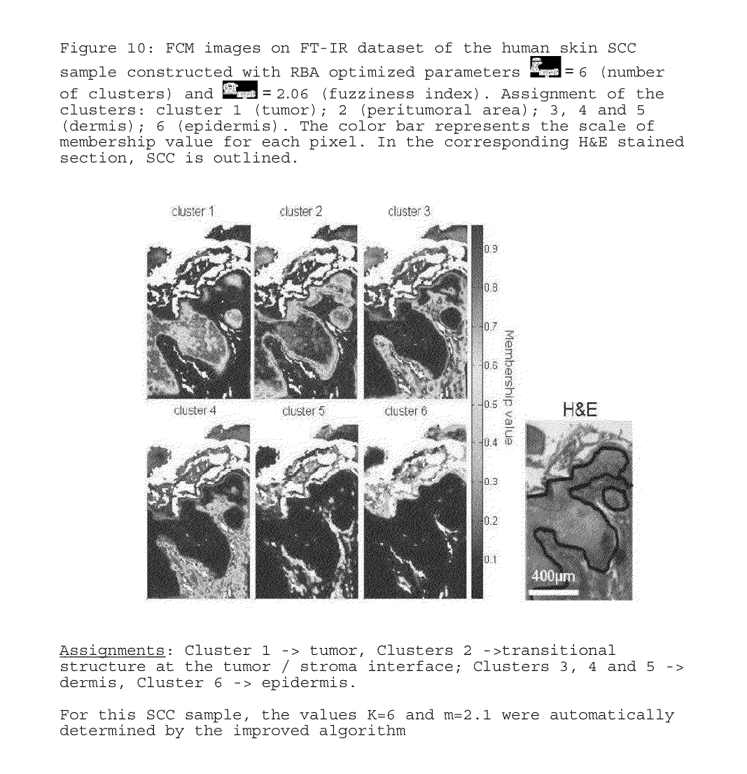

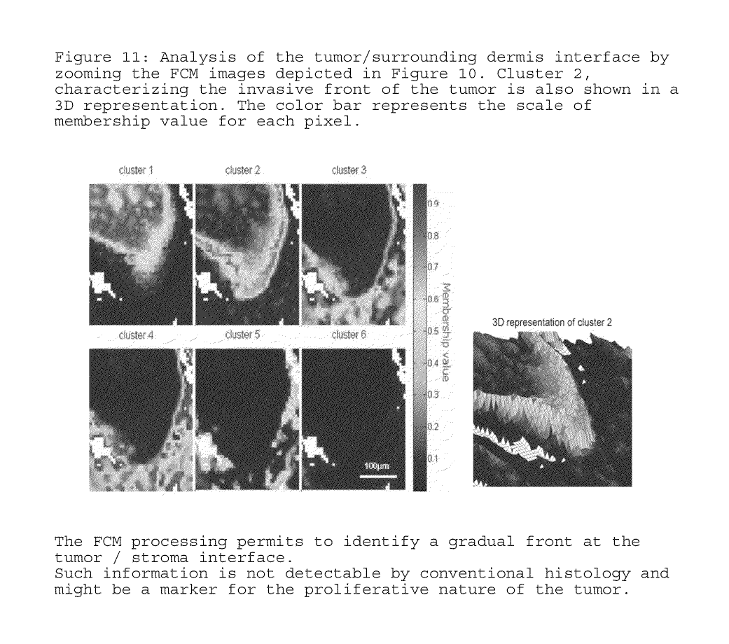

The images generated by the FCM-RBA are depicted in FIG. 10 for the human infiltrative skin SCC. After comparison with the histological image, each generated cluster was assigned to a precise tissue structure: tumoral area (cluster 1), peritumoral area (cluster 2), dermis (clusters 3, 4 and 5), and epidermis (cluster 6). Moreover, FCM-RBA revealed new information which was not accessible by conventional histology or classical “hard” clustering methods. Indeed, it highlighted the presence of a marked heterogeneity both within the tumor as shown for cluster 1 and within the peritumoral area as shown for cluster 2. Compared to “hard” clustering, FCM-RBA allowed to visualize within each of these clusters, spectral nuances corresponding to membership grade variations of the pixels. These spectral differences relied on molecular changes within tissue structures that could reflect changes in the structure/function of the tumor cells present in these areas. Interestingly, as shown in FIG. 11 using a 3D representation of the peritumoral area (cluster 2), FCM-RBA revealed the presence of a progressive gradient in the membership values of the pixels. From tumor towards dermis, the membership value of each pixel gradually increased to reach a maximum and then, decreases sharply at the edge of the dermis. This indicated both a tight connexion between the tumor (cluster 1) and its invasive front (cluster 2), and a surprising clear-cut difference between the invasive front (cluster 2) and the surrounding dermis (clusters 3, 4 and 5). On a pathological point of view, the peritumoral area was of great interest, since it represented the invasion front of the tumor where tumor cells can infiltrate the surrounding normal tissue. This approach showed significant potential for probing tumor progression, from carcinoma to metastases, and consequently may represent an attractive tool for early determination of tumor aggressiveness.

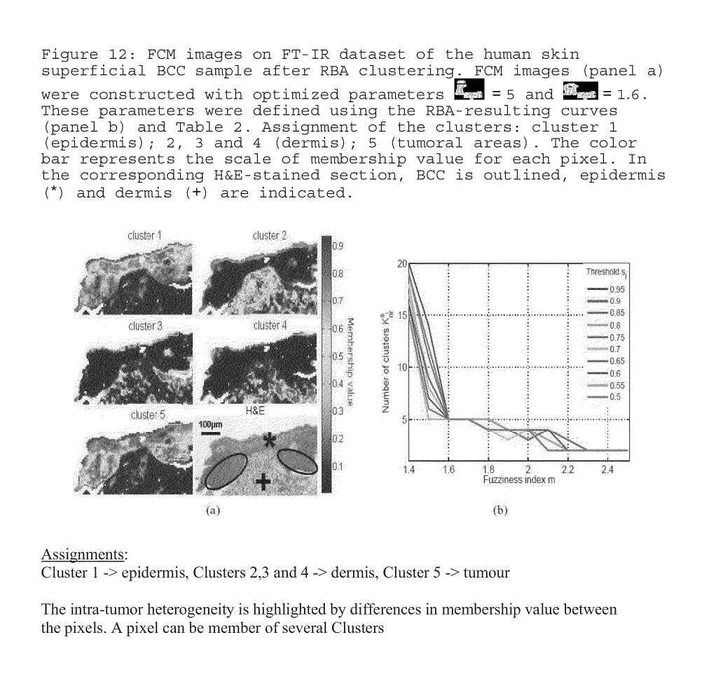

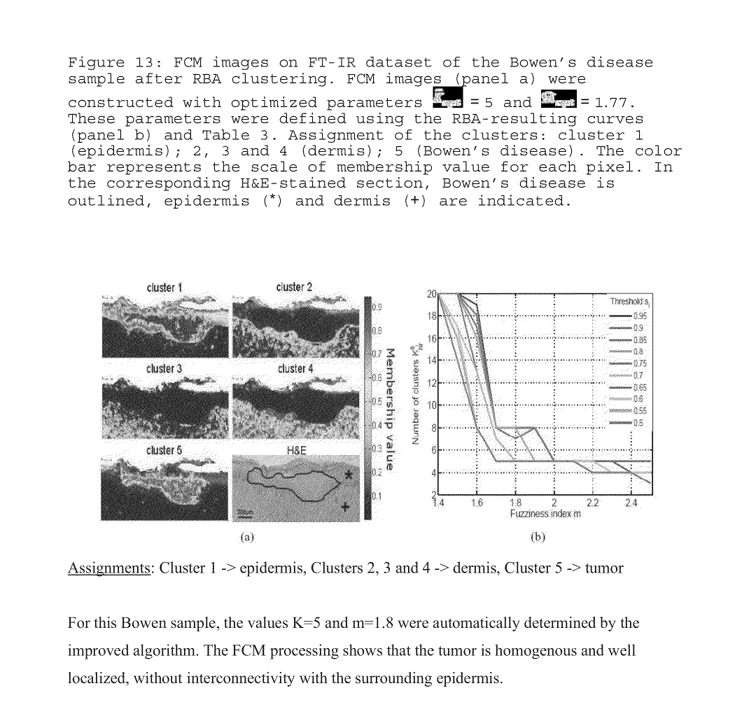

After having analyzed a SCC sample as a model of an infiltrative skin cancer, the FCM-RBA outcomes were presented for a superficial BCC and a Bowen's disease samples, both representative of non-invasive skin cancers. The optimization of FCM parameters by RBA are shown for these samples in FIGS. 12(b) and 13(b), and in Table 2 and Table 3, for BCC and Bowen's disease samples, respectively.

TABLE 2
Optimal number of clusters \hat{K}ₒₚₜ^{s}^{ₗ} and the corresponding optimal values
of the fuzziness index \hat{m}ₒₚₜ^{s}ₗ. These data have been determined for 10
different values of the threshold sₗ from the curves presented in FIG. 10(b).

| | sₗ | | | | | | | | | |
|---|---|---|---|---|---|---|---|---|---|---|
| | 0.95 | 0.9 | 0.85 | 0.8 | 0.75 | 0.7 | 0.65 | 0.6 | 0.55 | 0.5 |
| \hat{K}ₒₚₜ^{s}^{ₗ} | 5 | 5 | 5 | 5 | 5 | 5 | 5 | 5 | 5 | 5 |
| \hat{m}ₒₚₜ^{s}^{ₗ} | 1.6 | 1.6 | 1.6 | 1.6 | 1.6 | 1.6 | 1.6 | 1.6 | 1.5 | 1.6 |

TABLE 3
Optimal number of clusters \hat{K}ₒₚₜ^{s}^{ₗ} and the corresponding optimal values
of the fuzziness index \hat{m}ₒₚₜ^{s}ₗ. These data have been determined for 10
different values of the threshold sₗ from the curves presented in FIG. 13(b).

| | sₗ | | | | | | | | | |
|---|---|---|---|---|---|---|---|---|---|---|
| | 0.95 | 0.9 | 0.85 | 0.8 | 0.75 | 0.7 | 0.65 | 0.6 | 0.55 | 0.5 |
| \hat{K}ₒₚₜ^{s}^{ₗ} | 8 | 5 | 8 | 8 | 5 | 5 | 5 | 5 | 5 | 5 |
| \hat{m}ₒₚₜ^{s}^{ₗ} | 1.7 | 2 | 1.7 | 1.7 | 1.8 | 1.8 | 1.7 | 1.7 | 1.7 | 1.7 |

As shown in FIG. 12(a), for the superficial BCC, FCM-RBA revealed 5 clusters that could be easily assigned to separate tissue structures: epidermis (cluster 1), dermis (clusters 2, 3 and 4) and tumoral areas (cluster 5). Compared to “hard” clustering (FIG. 3), fuzzy clustering identified intratumoral heterogeneities within cluster 5, as already described for cluster 1 of the previous SCC sample. An additional original information was evidenced at the tumor (cluster 5)/normal epidermis (cluster 1) interface. Indeed, a progressive transition from tumor towards epidermis was observed, reflecting an interconnectivity between these two regions. This can be explained by the fact that BCC originates from cell transformation of epidermal keratinocytes. It should be noted, that to our knowledge, such tissular interdependence, not identified by conventional histopathology, has never yet been described. In addition, contrary to the infiltrative SCC, the tumor (cluster 5)/dermis (clusters 2, 3 and 4) interface did not present any intermediary peritumoral structure, but rather the existence of a well-defined edge that confirmed the non-infiltrative phenotype of BCC.

For the Bowen's disease sample, FCM-RBA revealed 5 clusters that were assigned to the following histological structures: epidermis (cluster 1), dermis (clusters 2, 3 and 4) and tumor (cluster 5). Visual comparative analysis of clusters 1 and 5 indicated that the tumor was well-localized within the normal epidermis. In addition, FCM-RBA did not reveal the presence of a gradient in the membership values of the pixels at the tumor/neighboring epidermis interface. Contrary to the SCC and BCC studied samples, this absence of interconnectivity was in accordance with the fact that Bowen's diseases corresponded to well-localized in situ carcinomas.

### Conclusions:

Spectral micro-imaging associated with clustering techniques showed a great potential for the direct analysis of paraffin-embedded tissue sections of human skin cancers. Our results demonstrated that FCM clustering is more powerful than classical “hard” clustering (KM and hierarchical classification) to reveal biologically-relevant information related to the tumor heterogeneity and invasiveness. Thus, we developed an original algorithm dedicated to the simultaneous determination of the optimal FCM parameters (number of clusters K, and fuzziness index m). This novel data processing makes FT-IR or Raman micro-imaging a promising tool, independent of the intraobserver variability, for applications in routine diagnostic medicine.

1. A fuzzy C-means (FCM) clustering algorithm for processing spectral images of a tissue sample, wherein the algorithm automatically and simultaneously estimates the optimal values of K (number of non-redundant FCM clusters), and m (fuzziness index), based on the redundancy between FCM clusters.

2. An algorithm according to claim 1, wherein the redundancy is calculated by:
$${R}_{ij} ( K , m ) = \frac{C ( i , j )}{\sqrt{C ( i , i ) C ( j , j )}}$$
wherein Rᵢⱼ is intercorrelation coefficient between two clusters i and j as the measure of redundancy; c(i,j)=Σ_{q=1}^{Q}(u_{qi}−ūᵢ)(u_{qj}−ūⱼ) is the covariance between the membership values of clusters i and j given by FCM for a couple (K,m); and c(i,i)=Σ_{q-1}^{Q}(u_{qi}−ūᵢ)² and c(j,j)=Σ_{q=1}^{Q}(u_{qj}−−ūⱼ)² are the variances of the membership values of cluster i and j, with the means
$${\overline{u}}_{i} = \frac{1}{Q} {\sum }_{q = 1}^{Q} {u}_{qi} and {\overline{u}}_{j} = \frac{1}{Q} {\sum }_{q = 1}^{Q} {u}_{qj} .$$

3. An algorithm according to claim 2, wherein the algorithm comprising: 1) iterative process of cluster number reduction to determine the number of non-redundant clusters in function of m for L different threshold values of the correlation coefficients, resulting in the construction of L curves; 2) optimal estimating of FCM parameters from the L curves; 3) identifying the final optimal value \hat{K}ₒₚₜ, of the number of clusters; and 4) computing optimal value \hat{m}ₒₚₜ of the fuzziness index.

4. An algorithm according to claim 3, wherein the optimal values of K and m are estimated without a priori knowledge of the dataset.

5. An algorithm according to claim 4, wherein each spectrum of the spectral images is assigned to every cluster with a specific membership value.

6. A method for characterizing the tumor heterogeneity of a lesion comprising: a) scanning a lesion on a tissue sample by a FTIR or Raman spectrometer coupled with a micro-imaging system; b) acquiring and storing spectra of a series of digital images of the lesion; c) clustering the spectra by fuzzy C-means (FCM) clustering algorithm wherein the algorithm automatically and simultaneously estimates the optimal values of K (number of non-redundant FCM clusters), and m (fuzziness index), based on the redundancy between FCM clusters.

7. A method according to claim 6, wherein the redundancy is calculated by:
$${R}_{ij} ( K , m ) = \frac{C ( i , j )}{\sqrt{C ( i , i ) C ( j , j )}}$$
wherein Rij is intercorrelation coefficient between two clusters i and j as the measure of redundancy; c(i,j)=Σ_{q=1}^{Q}(u_{qi}−ūᵢ)(u_{qj}−ūⱼ) is the covariance between the membership values of clusters i and j given by FCM for a couple (K,m); and c(i,i)=Σ_{q-1}^{Q}(u_{qi}−ūᵢ)² and c(j,j)=Σ_{q=1}^{Q}(u_{qj}−−ūⱼ)² are the variances of the membership values of cluster i and j, with the means
$${\overline{u}}_{i} = \frac{1}{Q} {\sum }_{q = 1}^{Q} {u}_{qi} and {\overline{u}}_{j} = \frac{1}{Q} {\sum }_{q = 1}^{Q} {u}_{qj} .$$

8. A method according to claim 7, wherein the algorithm comprising: 1) iterative process of cluster number reduction to determine the number of non-redundant clusters in function of m for L different threshold values of the correlation coefficients, resulting in the construction of L curves; 2) optimal estimating of FCM parameters from the L curves; 3) identifying the final optimal value \hat{K}ₒₚₜ, of the number of clusters; and 4) computing optimal value \hat{m}ₒₚₜ of the fuzziness index.

9. A method according to claim 8, wherein the optimal values of K (\hat{K}ₒₚₜ) and m (\hat{m}ₒₚₜ) are estimated without a priori knowledge of the dataset.

10. A method according to claim 9, wherein each spectrum of the spectral images is assigned to every cluster with a specific membership value.

11. A method according to claim 6, wherein the method further comprises: d) comparing the cluster-membership information to a spectral library of various tumoral tissues to identify spectral markers of each tissue type of the cutaneous tumors; and e) mapping the spectral markers by assigning a color to each different cluster.

12. A method according to claim 11, wherein the method differentiates the tumoral tissue and the tumor/peritumoral tissue interface.

13. A method according to claim 12, wherein the method reveals a progressive gradient in the membership values of the pixels of the peritumoral tissue.

14. A method according to claim 12, wherein the tumoral tissue is the tissue of skin carcinomas.

15. A method according to claim 12, wherein the tumoral tissue is the tissue of an infiltrative SCC.

16. A method according to claim 12, wherein the tumoral tissue is the tissue of a non-infiltrative state of a superficial BCC.

17. A method according to claim 12, wherein the tumoral tissue is the tissue of a Bowen's disease.
